(19) United States
(12) Patent Application Publication
(10) Pub. No.: US 2012/0164317 A1
(43) Pub. Date: Jun. 28, 2012

(54) METHOD FOR FABRICATING POLARIZER

(75) Inventors: Zin Sig KIM, Daejeon (KR); Kyu Ha Baek, Daejeon (KR); Lee Mi Do, Daejeon (KR)

(73) Assignee: Electronics and Telecommunications Research Institute, Daejeon (KR)

(21) Appl. No.: 13/330,527

(22) Filed: Dec. 19, 2011

(30) Foreign Application Priority Data
Dec. 23, 2010 (KR) 10-2010-0134035

(51) Int. Cl. B05D 5/06; B05D 3/12; B05D 5/12; B82Y 30/00

(52) U.S. Cl. 427/122; 427/58; 427/126.3; 427/126.4; 977/742

(57) ABSTRACT

Provided is a method for fabricating a polarizer. The method includes forming an unevenness structure pattern on a substrate, coating conductive nano-particles on an entire surface of the unevenness structure pattern, and planarizing an entire surface of the resultant substrate after the conductive nano-particles are coated on the unevenness structure pattern.

### CROSS-REFERENCE TO RELATED APPLICATIONS

The present application claims priority to Korean patent application number 10-2010-0134035, filed on Dec. 23, 2010, which is incorporated by reference in its entirety.

### BACKGROUND OF THE INVENTION

The present invention relates to a method for fabricating a polarizer, and more particularly, to a method for fabricating a polarizer, which forms an unevenness structure pattern on a substrate and coats conductive nano-particles on the substrate having the unevenness structure pattern to remove extra nano-particles and planarize the resultant substrate, thereby fabricating the polarizer.

With the development of various portable electronic devices such as mobile phones, PDAs (personal digital assistants), notebook computers, and the like, a demand for a flat panel display device that is thin, small and lightweight has recently increased. Furthermore, it is required to increase functions of a semiconductor device and decrease a size of the semiconductor device. Various display devices, such as liquid crystal displays (LCD), plasma display panels (PDP), field emission displays (FED), and vacuum fluorescent displays (VFD), have been actively studied for use as a flat panel display device. Of them, the LCD is being spotlighted as the preferred flat panel display device because of its simplicity to mass-produce, its facile driving method, and its high-resolution image.

Also, now that the vast majorities are development of low prices, simplified processes, environment-friendliness processes during the fabrication of an optical film in optical film fields of the semiconductor device.

Specifically, in the fabrication of the polarizer and optical film, light use efficiency and simplified processes are considered very important.

The above-described technologies may mean the background in the art of the present invention, but do not mean the related art.

In a method for fabricating a polarizer, a method using a meso porous material has a limitation in which a meso porous material having a channel therein should be manufactured or a metal material should be filled into the channel of the meso porous material. Also, a method using a nano-wire array has a limitation a structure having nano-wires arranged in parallel along a main axis on a surface of a matrix layer should be manufactured. Also, a method using a nano-mask has a limitation in which a thin and long nano-mask having a shape equal to that of a section of a wavelength having a period of approximately 150 nm or less should be manufactured to etch a surface layer and a metal layer, thereby transferring periodic patterns.

### SUMMARY OF THE INVENTION

Embodiments of the present invention are directed to a method for fabricating a polarizer, which forms an unevenness structure pattern on a substrate and coats conductive nano-particles on the substrate having the unevenness structure pattern to remove extra nano-particles and planarize the resultant substrate, thereby fabricating the polarizer.

In one embodiment, a method for fabricating a polarizer includes: forming an unevenness structure pattern on a substrate; coating conductive nano-particles on an entire surface of the unevenness structure pattern; and planarizing an entire surface of the resultant substrate after the conductive nano-particles are coated on the unevenness structure pattern.

In the present invention, the unevenness structure pattern may be formed by a nanoimprint process.

In the present invention, the unevenness structure pattern may be formed by an e-beam lithography process.

In the present invention, the conductive nano-particles may include at least one kind of metal oxides selected from the group consisting of zirconium, aluminum, germanium, and titanium.

In the present invention, the conductive nano-particles may include one of a conductive polymer material, a carbon nano-tube (CNT), and a graphene.

In the present invention, the coating of the conductive nano-particles may include coating the conductive nano-particles under a vacuum condition.

In the present invention, the coating of the conductive nano-particles may include coating the conductive nano-particles under an atmospheric condition.

In the present invention, the planarizing of the entire surface of the resultant substrate may include removing extra conductive nano-particles with respect to a top surface of the unevenness structure pattern through a doctor-blade method.

In the present invention, the planarizing of the entire surface of the resultant substrate may include removing extra conductive nano-particles with respect to a top surface of the unevenness structure pattern through a roller method.

The present invention may further include forming a protection layer after the planarization process is performed.

The present invention may further include forming an adhesion layer before the protection layer is formed.

### BRIEF DESCRIPTION OF THE DRAWINGS

FIGS. 1 to 6 illustrate a method for fabricating a polarizer according to an embodiment of the present invention.

### DESCRIPTION OF SPECIFIC EMBODIMENTS

Hereinafter, a method for fabricating a polarizer in accordance with the present invention will be described in detail with reference to the accompanying drawings. Herein, the drawings may be exaggerated in thicknesses of lines or sizes of components for the sake of convenience and clarity in description. Furthermore, terms used herein are defined in consideration of functions in the present invention and may be varied according to the custom or intention of users or operators. Thus, definition of such terms should be determined according to overall disclosures set forth herein.

FIGS. 1 to 6 illustrate a method for fabricating a polarizer according to an embodiment of the present invention.

As shown in FIG. 1, an unevenness pattern 102 is formed on a substrate 101.

Here, the unevenness structure pattern 102 may be variously modified in depth, width, and length in consideration of a use of a polarizer and a wavelength of light.

A nanoimprint process in which the substrate 101 may be pressed by a mold (not shown) having fine nano-unevennesses may be performed to form the unevenness structure pattern 102. Alternatively, an e-beam lithography process using an e-beam may be performed to directly form the unevenness structure pattern 102 on the substrate 101.

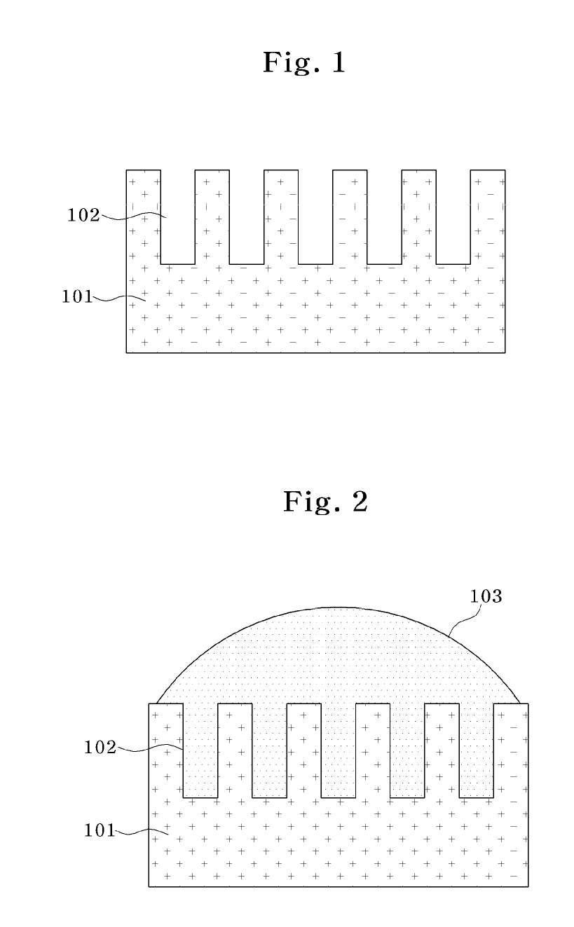

As shown in FIG. 2, after the unevenness structure pattern 102 is formed on the substrate 101, solution, paste or fine powder containing conductive nano-particles 103 may be coated to fill the conductive nano-particles 103 into the unevenness structure pattern 102. Here, when the conductive nano-particles 103 are filled into the unevenness structure pattern 102, the conductive nano-particles 103 may be coated under an atmospheric condition. Alternatively, when the conductive nano-particles 103 are filled into the unevenness structure pattern 102, the conductive nano-particles 103 may be coated under a vacuum condition to remove bubbles.

For example, the conductive nano-particles 103 may include at least one kind of metal oxides selected from the group consisting of zirconium, aluminum, germanium, and titanium. Alternatively, the conductive nano-particles 103 may include a conductive polymer material, a carbon nano-tube (CNT), or a graphene.

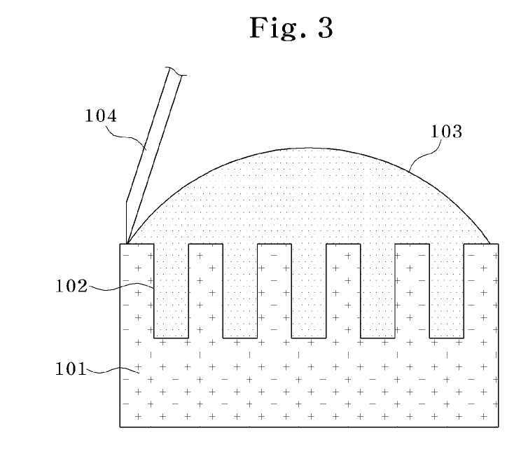

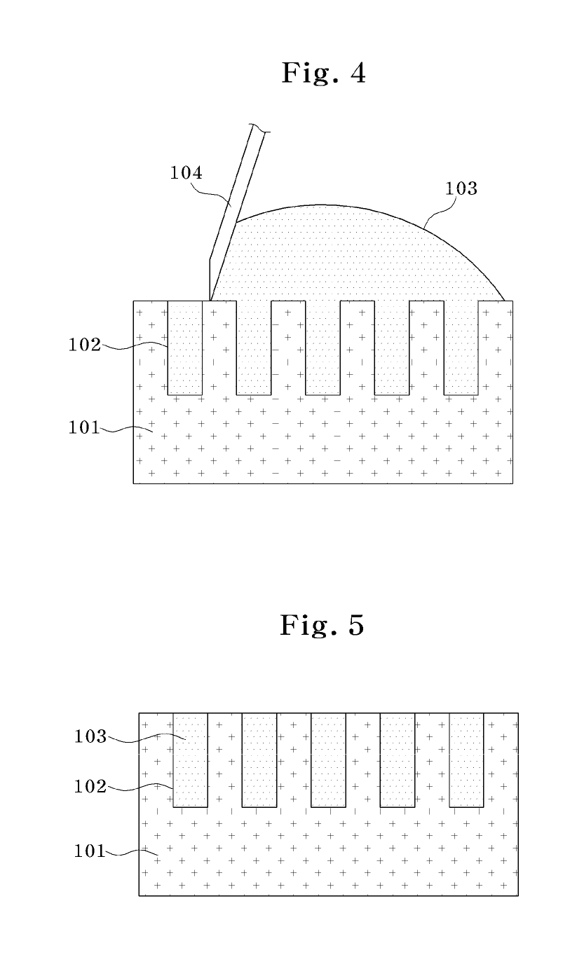

As shown in FIGS. 3 and 4, extra conductive nano-particles 103 may be removed with respect to an entire surface of the substrate 101, i.e., a top surface of the unevenness structure pattern 102 using a doctor-blade 104 or a roller (not shown) to manufacture a polarizer of FIG. 5.

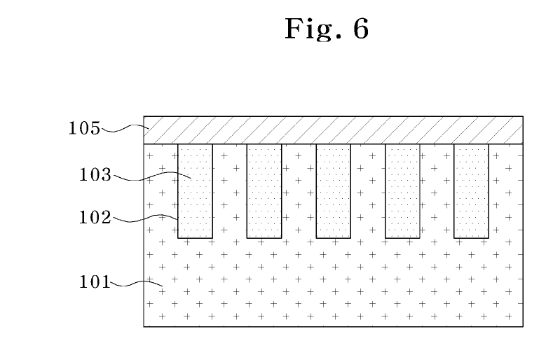

As shown in FIG. 6, a protection layer 105 is formed on an entire top surface of the polarizer. Here, the protection layer 105 may be formed on a bottom surface of the polarizer.

When the protection layer 105 is formed, an adhesion layer (not shown) may be formed, and then the protection layer 105 may be formed to enhance adhesive efficiency with the polarizer.

Here, the protection layer 105 and the adhesion layer may have a transparent or opacity property.

As described above, since the unevenness structure pattern is formed on the substrate, and then the conductive nano-particles are coated to remove the extra nano-particles and planarize the resultant substrate, the process for fabricating the polarizer may be simplified.

While the present invention has been described with respect to the specific embodiments, it will be apparent to those skilled in the art that various changes and modifications may be made without departing from the spirit and scope of the invention as defined in the following claims.

What is claimed is:

1. A method for fabricating a polarizer, the method comprising:
forming an unevenness structure pattern on a substrate;
coating conductive nano-particles on an entire surface of the unevenness structure pattern; and
planarizing an entire surface of the resultant substrate after the conductive nano-particles are coated on the unevenness structure pattern.

2. The method of claim 1, wherein the unevenness structure pattern is formed by a nanoimprint process.

3. The method of claim 1, wherein the unevenness structure pattern is formed by an e-beam lithography process.

4. The method of claim 1, wherein the conductive nano-particles comprises at least one kind of metal oxides selected from the group consisting of zirconium, aluminum, germanium, and titanium.

5. The method of claim 1, wherein the conductive nano-particles comprise one of a conductive polymer material, a carbon nano-tube (CNT), and a graphene.

6. The method of claim 1, wherein the coating of the conductive nano-particles comprises coating the conductive nano-particles under a vacuum condition.

7. The method of claim 1, wherein the coating of the conductive nano-particles comprises coating the conductive nano-particles under an atmospheric condition.

8. The method of claim 1, wherein the planarizing of the entire surface of the resultant substrate comprises removing extra conductive nano-particles with respect to a top surface of the unevenness structure pattern through a doctor-blade method.

9. The method of claim 1, wherein the planarizing of the entire surface of the resultant substrate comprises removing extra conductive nano-particles with respect to a top surface of the unevenness structure pattern through a roller method.

10. The method of claim 1, further comprising forming a protection layer after the planarization process is performed.

11. The method of claim 10, further comprising forming an adhesion layer before the protection layer is formed.
